(19) United States
(12) Patent Application Publication
(10) Pub. No.: US 2011/0038502 A1
(43) Pub. Date: Feb. 17, 2011

(54) Electret Capacitor Microphone with One-Piece Vocal Cavity Component

(75) Inventors: Ho Shun Shiu, Zhejiang (CN); Zhiqing Hu, Zhejiang (CN); Jianyong Wu, Zhejiang (CN); Xiaowen Chen, Zhejiang (CN)

Correspondence Address: GLOBAL IP SERVICES, 7285 W. Eagle Court, Winton, CA, 95388, US

(73) Assignee: WELL INLAND MULTIMEDIA MANUFACTURE (NINGBO) CO., LTD., Ningbo, Zhejiang (CN)

(21) Appl. No.: 12/989,259

(22) PCT Filed: Apr. 21, 2009
(86) PCT No.: PCT/CN2009/071392

§ 371 Date: Oct. 22, 2010

(30) Foreign Application Priority Data
Apr. 22, 2008 (CN) 200810060671.1

(51) Int. Cl. H04R 11/04; H04R 19/01

(52) U.S. Cl. 381/355; 381/191; 381/174

(57) ABSTRACT

An electret capacitor microphone with one-piece vocal cavity component includes; a shell, a vibration element and a circuit board which is used to envelop the shell containing cavity and connect with the shell; the first vocal cavity is formed between the vibration element and the inner surface of the top of the shell; voice holes are connected with the first vocal cavity; wherein, one-piece vocal component that lies between the vibration element and circuit board is installed in the shell. The one-piece vocal cavity component is formed by an annular sidewall and a cavity board formed in one-piece on the annular sidewall. A through-hole is formed on the cavity board and inner concave at lower end of an annular sidewall. The second vocal cavity is formed between the annular sidewall and the cavity board. An external surface of the annular sidewall is coated with an insulating material layer.

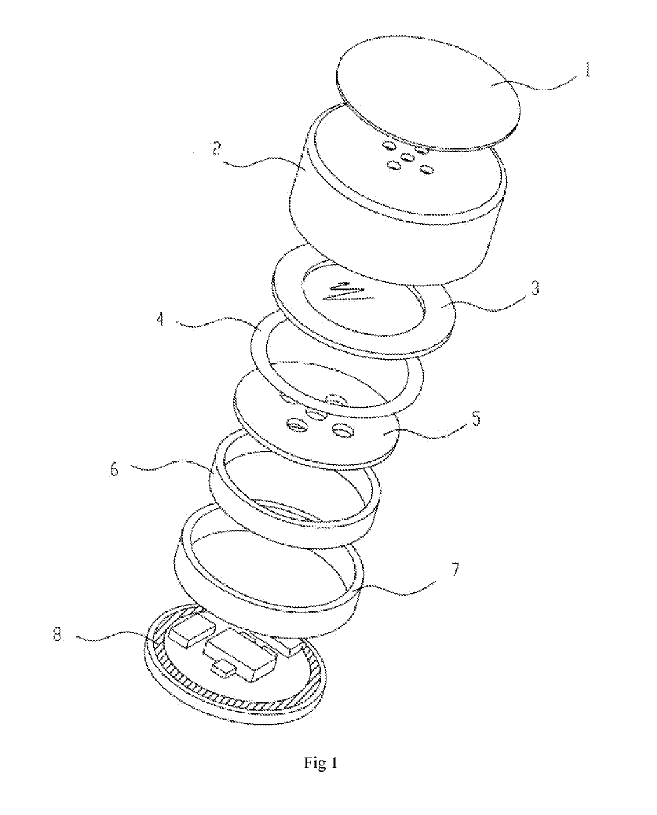

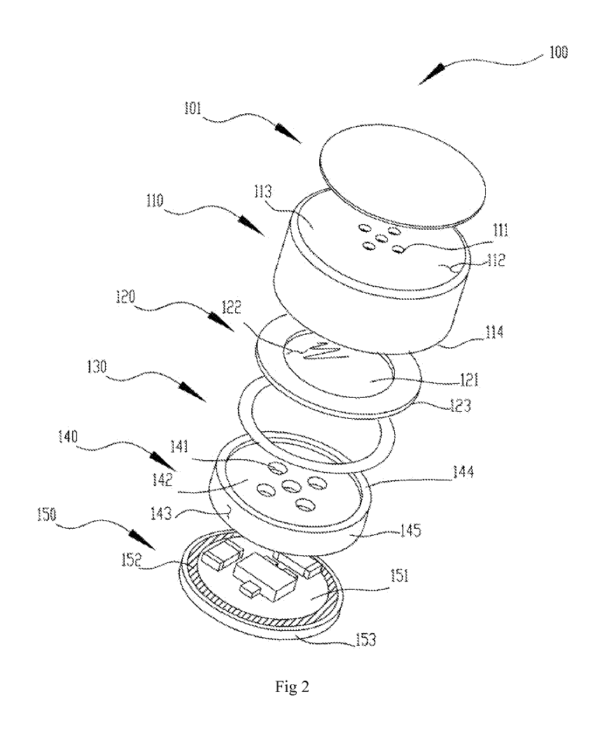

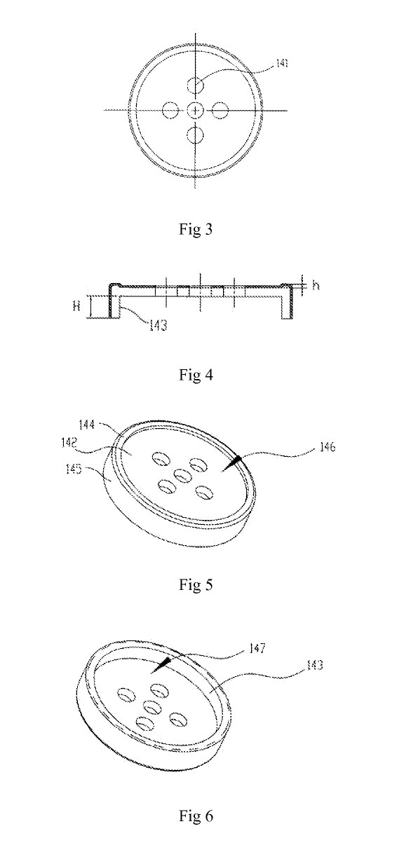

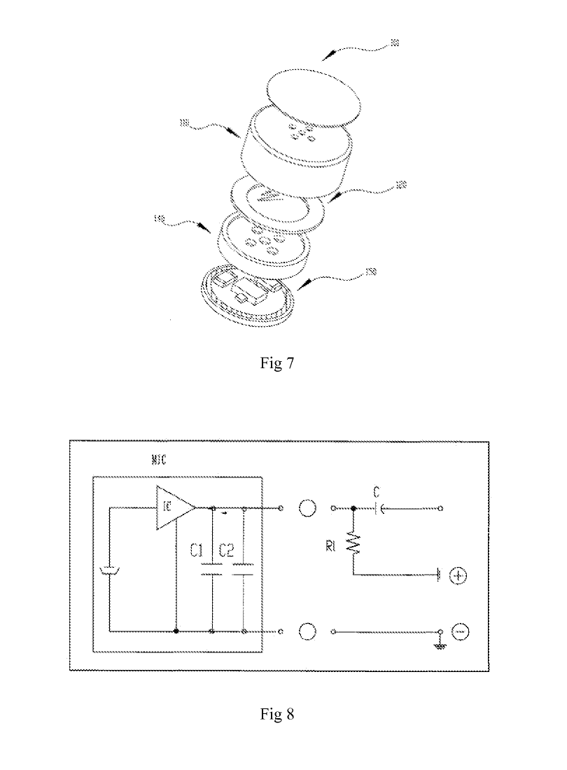

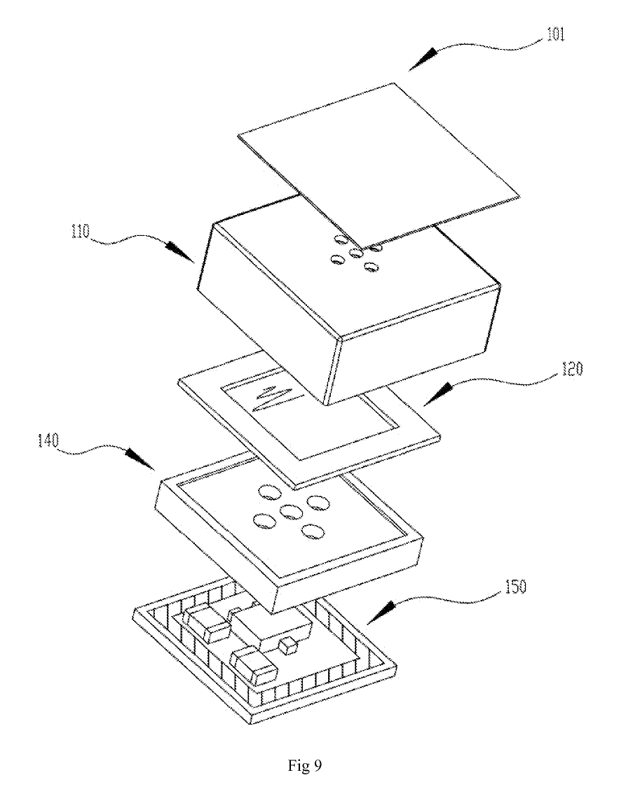

### FIELD OF THE INVENTION

This invention refers to microphone which is featured by one-piece vocal cavity component, belonging to the field of vocal equipment.

### BACKGROUND OF THE INVENTION

Over the years, microphone that transforming sound wave to electrical signal is increasingly used to communication industry (for example, telephone, mobile), multi-media computer system (VoIP), electronic toy (for example, electronic game console, sound-controlled toy) and stereo equipment (for example, DC, DV, MP3, MP4, hands-free audiofrequency components) and other kind of products, electret capacitance microphone (EMC) is widely applied among them. It usually includes metal shell which is surrounded by top surface and side wall, there are many holelike sound channel on the top of shell; vibrating board inside the shell includes metal ring and vibrating diaphragm on the ringlike head face, back polar board; plastic ring which is installed between back polar board and metal ring, can form a certain distance between back polar board and vibrating diaphragm; copper frame which is installed under the back polar board, connecting between back polar board and copper pour electricity of circuit of technotron (JFET). In order to avoid back polar board and copper frame are connected to shell electricity, usually there is plastic ringlike frame installed outside of them and make them insulated.

When electret capacitance microphone is working, the sound wave enters into the shell through holelike channel, which leads to the vibration of vibrating diaphragm, and the distance of flat capacitance which is formed between vibrating diaphragm and back polar board will be changed, and then flat capacitance will be caused to change accordingly, because there is electret material on the vibrating diaphragm and back polar board, one of them can be chosen and electreted in advance, the electret material can restrict electric charge, thus there is stable quantity of electricity among capacitances. Therefore, the voltage of capacitance of two ends will be caused to change when distance changing between positive and negative polar plates, so the formed acoustoelectric effect will lead to feeble electric signal, and then electric signal will be passed to circuit board through copper frame, and it will be output and transformed to demanded electrical signal after treatment of electric components on circuit board.

When installation, put vibrating board inside the shell firstly, secondly put plastic ring, then put back polar board, copper frame and plastic frame accordingly, put circuit board to seal the entrance and install dust-proof clothing on the shell to finally. It can be seen from this, existing components are not less than 8 pieces, at least eight different procedures are needed, the accumulating differences for every component will be big degree of error, because there are many components with small volume, so the working accuracy is highly required, the assembling is more difficult, which directly affect the percent of qualified, consistency of finished products, material cost and labor cost. Furthermore, the current situation of the basic production assembling procedure is long, procedures are much, and components are exposed in the air for long time and hand-operated is frequency, these two procedures make components stick to sundries and dust easily, affecting sensitivity and the rate of qualified products.

### SUMMARY OF THE INVENTION

The technology problem and technology task of this invention is to overcome existing technology shortcomings, offer a kind of electret microphone with one-piece vocal cavity constructional components, it must be less components, smaller accumulating differences, more simple assembling procedures, convenient assembling, low production cost, high rate of qualified products and more stable quality. Therefore, the technical proposal in this invention as followings:

There is a shell having cavity and a tune hole being on a top surface of the shell, a vibration element located in the shell, a circuit board used to connect with the shell; a first vocal cavity is formed between said vibration element and inner top surface of the shell; said voice hole is through to the first vocal cavity; an one-piece vocal cavity component located between the vibration element and the circuit board comprising a ringlike side wall and a cavity board integrated with the side wall, there is a through hole on the cavity board which is sunken in the side wall, the side wall, cavity board and vibration element define a second vocal cavity; outside of the side wall is coated by insulation-material layer. One-piece vocal cavity component with special structure omits back polar board, copper frame and plastic frame and other components that included in traditional electret capacitance; cavity board, side wall and insulation material layer is equivalent to back polar board, copper frame and plastic frame, one component, but multi-function of connecting with capacitance polar board, circuit board electricity and isolated from shell, the quantity of components is reduced, the whole structure and production procedure are simplified, the assembling relation of necessary components is improved, and the accumulating differences of components is reduced effectively; it is also convenient to assembling, shorten the assembling time, that is, the exposed time in air and hand-operated time is shortened, thus make sure components' sensitivity, and improve product quality, rate of qualified product, and reduce production cost. There is no limitation for the shape of side wall, it can be round, square, triangle or oval etc, also it can be constant sealed ring or interrupted saw-tooth and any other status, only if the insulation material on its surface between side wall and shell is workable. All other surface of side wall of one-piece vocal cavity component except side wall can be coated with insulation material or without insulation material. If coated with insulation material, then the material can be electret material within certain quantity of electrical charge in advance.

For the improvement and supplement of above proposal, following technique features can be added:

Said one-piece vocal cavity component is made of conducting materials. And this materials must meet the requirement of forming polar board at one end of capacitance.

The microphone also contains a insulation ring which is between the vibration element and the one-piece vocal cavity component. When the roof of one-piece vocal cavity is flat, the insulation ring will apart vibration element from one-piece vocal cavity component in certain distance, so that the plate capacitor can be formed, and offer vibration element with space to generate vibration, thus form electrical signal of sound wave vibration.

Said capacitor chamber formed on top of the side wall is sunken in the inner cavity board, thereby, the one-piece vocal cavity constructional components comprises the consender chamber at upper side and a second vocal cavity at lower side, there is a protruded shoulder formed on the upper side of cavity board surface, its side face and top surface are coated with insulation-material layer. Embossing part is set on one-piece vocal cavity component, aparting vibration element from one-piece vocal cavity component, so that plate capacitor can be formed, also the plastic ring in traditional structure can be replaced, further optimizing the whole structure of product, reducing component quantity of product and accumulating rate of error, improving assembling efficiency. Inner side face of embossing part can be coated with insulating material layer, also can be without.

An input terminal is set on the said circuit board, a bottom of the said side wall is connected to the input terminal electricity. One-piece vocal cavity component transform the electrical signal of sound wave to circuit board through bottom of side wall, and the treatment and output will be proceed by whose electrical parts, usually input terminal can be copper pouring part of circuit board.

Said vibration element comprises a vibrating diaphragm and a ringlike part, said vibrating diaphragm is made of insulation material, upper surface of the vibrating diaphragm is coated with a metal-material layer, the ringlike part is set on top of the metal-material layer, the ringlike part is connected with the shell, a back surface of the vibrating diaphragm is connected to protruded shoulder. Insulating material can be regarded as electret material to restrict certain quantity of electrical charge in advance, when vibrating diaphragm is vibrating, the signal will be formed, ring parts apart the inner surface of shell roof from vibrating diaphragm, so that some space can be made between them, and easy for vibrating diaphragm to vibrate, also the admittance can be made between metal material layer of vibrating diaphragm and shell electricity.

This invention of one-piece vocal cavity component replaced the back polar board, copper frame and plastic frame and other components that included in traditional electret capacitance, meanwhile multi-function for multi-components is realized, the current procedure of assembling by loose mail article totally has been improved to choose some components and make them all-in-one, the quantity of components is reduced, the whole structure, assembling relation and production procedure are optimized, and the accumulating differences of components is reduced too; it is also convenient to assembling, shorten the assembling time, that is, the exposed time in air and hand-operated time is shortened, thus make sure components' sensitivity, and improve product quality, rate of qualified product, and reduce production cost.

### BRIEF DESCRIPTION OF THE DRAWINGS

Drawing 1 pictorial assembling structure drawing for current technology;

Drawing 2 pictorial assembling structure drawing for example 1 of the invention;

Drawing 3 planar structure drawing for vocal cavity component of example 1 of the invention.

Drawing 4 cutaway structure drawing for vocal cavity component of example 1 of the invention.

Drawing 5 front-pictorial structure drawing for vocal cavity component of example 1 of the invention.

Drawing 6 reverse side-pictorial structure drawing for vocal cavity component of example 1 of the invention.

Drawing 7 pictorial assembling structure drawing for example 2 of the invention;

Drawing 8 circuit schematic diagram of circuit board of the invention;

Drawing 9 pictorial assembling structure drawing for example 3 of the invention;

In drawing: 1 dust-proof clothing, 2 aluminum detonator, 3 vibrating plate 4 plastic ring, 5 back polar plate, 6 copper frame, 7 plastic frame, 8 circuit board, 100 electret capacitance microphone with one-piece vocal cavity component, 101 dust-proof clothing, 110 shell, 111 voice hole, 112 inner surface of roof, 113 outside surface of roof, 114 connecting surface of shell, 120 vibration elements, 121 upper surface of vibrating diaphragm, 122 low surface of vibrating diaphragm, 123 ring components, 130 insulation ring, 140 one-piece vocal cavity component, 141 pylome, 142 upper surface of cavity board, 143 inner surface, 144 embossing part, 145 side wall, 146 capacitor chamber, 147 second vocal cavity, 150 circuit board, 151 upper surface of circuit, 152 input terminal, 153 outside surface of circuit board.

### DETAIL DESCRIPTION OF THE INVENTION

Below is the further explanation for the substantive features of the invention which is based on instruction drawing and concrete implementary method.

Based on drawing 1, an electret capacitance microphone with current technology, including dust-proof clothing 1, cavity which is surrounded by roof and side wall, and inverted bowl-shaped aluminum shell 2, there are many hole pattern channels on the roof of aluminum shell 2, allowing the sound enters into cavity; vibrating board 3 which is set inside the aluminum shell 2 and touching with side wall of inner side aluminum shell, including metal ring and vibrating diaphragm which is set below the ringlike head face of metal ring; back polar board 5; plastic ring 4 which is set between back polar board 5 and metal ring, certain space is made between back polar board and vibrating board; copper frame 7 which is set under the back polar board 5, making connected between back polar board 5 and input terminal electricity of circuit board 8 of junction type field effect transistor (JFET). In order to avoid electric connection between back polar board 5, copper frame 7 and aluminum shell 2, usually plastic ring frame 6 will be used outside to insulate between them.

As showed from drawing 2-6, implementing of example 1, electret capacitance microphone 100 with one-piece vocal cavity component, including metal material, sound aperture 111, cavity shell 110 which is surrounded by roof and shell wall, dust-proof clothing 101 applied on the outside surface of shell 110; vibration element 120 set in inner shell; vibration element 120 include vibrating diaphragm and ring components 123 which is made of metal materials, vibrating diaphragm is made of insulating material, metal material layer on the upper surface 121 of vibrating diaphragm, ring components 123 is set on the metal material layer to isolate vibrating diaphragm and upper surface of inner shell, it is easy for vibrating diaphragm to vibrate, electric connection between ring component 123 and shell 110 can be done through welding, cementation and other methods, in case some sundries and dust enter into the inside during the assembling, and affect sensitivity; circuit board 150 which is used to seal the cavity of shell 110 should be connected with surrounding electricity of shell 110; the first vocal cavity is formed between vibration element 120 and inner surface 112 of shell 110 roof; voice hole 111 is connected to the first vocal cavity; inside the shell 110 there are vibration element 120, one-piece vocal cavity component 140 between circuit board 150 which is made of conducting material layer, one-piece vocal cavity component 140 includes side wall 145 and the second vocal cavity which is unicased, indenting to cavity plate of low side wall (drawing 4, the part showing H), there are plural-thickness toward through-hole 141, side wall 145 is coated with insulating material layer, side wall 145 is formed to be cavity plate surroundings, also can be formed as inner side of surroundings, constant ring-like shape or non-constant embossing shape, only if its position is corresponding to input terminal 152 of circuit board 150.

Above side wall of upper surface 142 of cavity plate is formed to be embossing part 144, there is insulating layer on the outside side face and top surface. Below surface 122 of vibrating diaphragm is connected to embossing part 144. in order to enlarge space between vibrating diaphragm and one-piece vocal cavity component (drawing 4, the part showing H), plastic insulation ring 130 also can be set, when the value is showing 0, that is, upper surface of cavity plate 142 is flat and no embossing part 144 is set, then insulation ring 130 must be applied to guarantee the capacity plate antenna is formed.

Upper surface 151 of circuit board 150 is set with electrical components, input terminal 152 of ringlike copper pouring, bottom of side wall 145 is connected to electricity of input terminal 152 (touching connection, welding or any other fixed connecting methods), outside surface 153 of circuit board is connected to electricity of shell 110.

When assembling, install vibration elements 120, one-piece vocal cavity component 140 into cavity of shell 110 one by one, then make upper surface 151 of circuit board 150 corresponding to one-piece vocal cavity component and seal them at the entrance of shell, finally fasten them with the help of the machine such as hemming, welding, sweating or felting to keep contacting between the edge of circuit board 150 and shell 110.

As showed in drawing 7, example 2 is the proposal of setting coatings on upper surface 142 of cavity plate and insulating-material embossing part 144, insulating material layer can be coated on the roof and outside side face of embossing part 144, and no restriction for rest parts, at this time, no need to set insulation ring between vibration element and one-piece vocal cavity component, other sections are the same as example 1.

As showed in drawing 8, the bottom of one-piece vocal cavity 140 and side wall 145 is contacted with input terminal 152 of copper pouring of circuit board, the electrical components transforming coupling electric signal to circuit board 150 will deal with signal treatment, and output frequency signal. Also coupling electric signal can be transformed to circuit board 150 after modulus transform by transform components is done, and then output frequency signal.

As showed in drawing 9, the components in implementing 3 are changed to be square based on implementing 2.

As showed in drawing 2,7,9, electret capacitance microphone with one-piece vocal cavity component is the concrete example of this invention, and it has showed the outstanding substantial features and improvement of the invention, but according to practical usage demand, some amending on its material, shape, specification, quantity of holes and color and so on will not be mentioned more hereby.

1. An electret capacitor microphone with one-piece vocal cavity component comprising:
a shell (110) having cavity and a tune hole (111) being on a top surface of the shell,
a vibration element (120) located in the shell,
a circuit board (150) used to connect with the shell;
a first vocal cavity is formed between said vibration element (120) and inner top surface (112) of the shell (110);
said voice hole (111) is through to the first vocal cavity;
an one-piece vocal cavity component (140) located between the vibration element (120) and the circuit board (150) comprising a ringlike side wall (145) and a cavity board integrated with the side wall, there is a through hole (141) on the cavity board which is sunken in the side wall, the side wall (145), cavity board and vibration element define a second vocal cavity;
outside of the side wall (145) is coated by insulation-material layer.

2. The electret capacitor microphone with one-piece vocal cavity component of claim 1, wherein the one-piece vocal cavity component (140) is made of conducting materials.

3. The electret capacitor microphone with one-piece vocal cavity component of claim 1, wherein a insulation ring (130) is between the vibration element (120) and the one-piece vocal cavity component (140).

4. The electret capacitor microphone with one-piece vocal cavity component of claim 1, wherein a capacitor chamber (146) formed on top of the side wall (145) is sunken in the inner cavity board, thereby, the one-piece vocal cavity constructional components comprises the consender chamber (146) at upper side and a second vocal cavity (147) at lower side, there is a protruded shoulder (144) formed on the upper side of cavity board surface (142), its side face and top surface are coated with insulation-material layer.

5. The electret capacitor microphone with one-piece vocal cavity component of claim 4, wherein an input terminal (152) is set on the circuit board (150), a bottom of the side wall (145) is connected to the input terminal (152) electricity.

6. The electret capacitor microphone with one-piece vocal cavity component of claim 5, wherein the vibration element (120) comprises a vibrating diaphragm and a ringlike part (123), said vibrating diaphragm is made of insulation material, upper surface of the vibrating diaphragm (121) is coated with a metal-material layer, the ringlike part (123) is set on top of the metal-material layer, the ringlike part (123) is connected with the shell (110), a back surface (122) of the vibrating diaphragm is connected to protruded shoulder (144).

7. The electret capacitor microphone with one-piece vocal cavity component of claim 2, wherein a insulation ring (130) is between the vibration element (120) and the one-piece vocal cavity component (140).

8. The electret capacitor microphone with one-piece vocal cavity component of claim 2, wherein a capacitor chamber (146) formed on top of the side wall (145) is sunken in the inner cavity board, thereby, the one-piece vocal cavity constructional components comprises the consender chamber (146) at upper side and a second vocal cavity (147) at lower side, there is a protruded shoulder (144) formed on the upper side of cavity board surface (142), its side face and top surface are coated with insulation-material layer.

9. The electret capacitor microphone with one-piece vocal cavity component of claim 8, wherein an input terminal (152) is set on the circuit board (150), a bottom of the side wall (145) is connected to the input terminal (152) electricity.

10. The electret capacitor microphone with one-piece vocal cavity component of claim 9, wherein the vibration element (120) comprises a vibrating diaphragm and a ring-like part (123), said vibrating diaphragm is made of insulation material, upper surface of the vibrating diaphragm (121) is coated with a metal-material layer, the ringlike part (123) is set on top of the metal-material layer, the ringlike part (123) is connected with the shell (110), a back surface (122) of the vibrating diaphragm is connected to protruded shoulder (144).
